(19) United States
(12) Patent Application Publication
(10) Pub. No.: US 2017/0216960 A1
(43) Pub. Date: Aug. 3, 2017

(54) FRICTION STIR WELDING DEVICE, FRICTION STIR WELDING SYSTEM, AND FRICTION STIR WELDING METHOD

(71) Applicants: HONDA MOTOR CO., LTD., Tokyo (JP); FANUC CORPORATION, Minamitsuru-gun, Yamanashi (JP)

(72) Inventors: Mitsuru Sayama, Wako-shi (JP); Masaru Oda, Minamitsuru-gun (JP); Yoshitake Furuya, Minamitsuru-gun (JP)

(73) Assignees: HONDA MOTOR CO., LTD., Tokyo (JP); FANUC CORPORATION, Minamitsuru-gun, Yamanashi (JP)

(21) Appl. No.: 15/501,252

(22) PCT Filed: Aug. 5, 2015
(86) PCT No.: PCT/JP2015/072227

§ 371 Date: Feb. 2, 2017

(30) Foreign Application Priority Data
Aug. 11, 2014 (JP) 2014-163449

(51) Int. Cl. B23K 20/12; B25J 9/16

(52) U.S. Cl. CPC B23K 20/123; B23K 20/1245; B23K 20/125; B25J 9/1633; G05B 2219/45146

(57) ABSTRACT

Provided are a friction stir welding (FSW) device, FSW system, and FSW method with which it is possible to expand the applications of FSW while increasing processing accuracy. In a FSW device, when a first member to be welded and a second member to be welded are continuously welded by moving a processing tool in a linear or curved manner with the processing tool, while rotating, being pressed in the axial direction against the first member to be welded and the second member to be welded, a control device executes a reaction force correction control that controls the output of support member actuators so as to cancel the reaction force acting upon the processing tool as a result of the rotation of the processing tool.

### TECHNICAL FIELD

The present invention relates to a friction stir welding device, a friction stir welding system, and a friction stir welding method for continuously welding together a first member to be welded and a second member to be welded by moving a machining tool linearly or curvilinearly.

### BACKGROUND ART

A spot welding system 10 for spot welding members to be welded by friction stir welding (FSW) has been disclosed in Japanese Laid-Open Patent Publication No. 2003-205374 (hereinafter referred to as “JP2003-205374A”) (abstract, paragraph [0001]). The spot welding system 10 is made up from an articulated robot 11, an FSW head 12 attached to a distal end of a robot arm, a surface plate 13 that retains a workpiece W horizontally, and a controller 14. A welding tool 15 and a fixing device 16 are mounted on the FSW head 12. The fixing device 16 includes a cylindrical pressing member 19 and a spring 18. At the time of welding, the pressing member 19 is pressed against a surface of the workpiece W by the spring 18, thereby temporarily fixing the welding tool 15 on the workpiece W. Consequently, lateral runout due to a rotary counterforce of the welding tool 15 is prevented from occurring (abstract).

### SUMMARY OF INVENTION

With the spot welding system 10 of JP2003-205374A, since spot welding is performed, the system is not necessarily suitable for applications in which a welded portion is formed continuously in a linear or curvilinear manner, and the applications thereof are limited.

The present invention has been devised taking into consideration the aforementioned problems, and has the object of providing a friction stir welding device, a friction stir welding system, and a friction stir welding method in which, while enhancing machining accuracy, the applications of FSW can be expanded.

A friction stir welding device (FSW device) according to the present invention is characterized by being equipped with a machining tool, a rotary drive motor configured to rotate the machining tool, a support member configured to support the machining tool and the rotary drive motor, a support member actuator configured to displace the support member, and a controller configured to control the rotary drive motor and the support member actuator, wherein, when, in a state in which the machining tool while rotating is pressed in an axial direction thereof with respect to a first member to be welded and a second member to be welded, the machining tool is moved linearly or curvilinearly to thereby continuously weld together the first member to be welded and the second member to be welded, the controller executes a counterforce compensation control configured to control an output of the support member actuator so as to cancel out a counterforce that acts on the machining tool accompanying rotation of the machining tool.

According to the present invention, when the machining tool during rotation thereof is moved linearly or curvilinearly through the support member, a counterforce compensation control is executed for controlling the output of the support member actuator so as to cancel out the counterforce that acts on the machining tool accompanying rotation of the machining tool. Owing to this feature, by moving the machining tool while a deviation due to the counterforce that acts on the machining tool is compensated for, displacement of the machining tool can be controlled highly accurately. Consequently, it is possible to carry out friction stir welding (FSW) of the first member to be welded and the second member to be welded with high precision. As a result, it is possible to expand the application of FSW that is performed by moving the machining tool linearly or curvilinearly.

The controller may calculate a direction of the counterforce based on a direction of rotation of the machining tool and a target direction of advancement or an actual direction of advancement of the machining tool. In accordance with this feature, it is possible to highly accurately estimate the direction of the counterforce to be compensated. Consequently, it is possible to carry out FSW of the first member to be welded and the second member to be welded with higher precision.

The controller may calculate a magnitude of the counterforce based on an actual output or a target output of the rotary drive motor. Owing to this feature, it is possible to highly accurately estimate the magnitude of the counterforce to be compensated. Consequently, it is possible to carry out FSW of the first member to be welded and the second member to be welded with higher precision.

The support member may include an articulated arm, and a jig configured to support the machining tool and the rotary drive motor, the support member actuator may include a plurality of arm motors that are provided inside the articulated arm, and the jig may be attached to a distal end of the articulated arm. Owing to this feature, as a portion of the FSW device, it becomes possible to utilize a general-purpose articulated arm, whereby the cost of the FSW device as a whole can be reduced.

In the case that the jig is a C-shaped member, the machining tool and the rotary drive motor may be disposed on one end side of the C-shaped member, and a guided member may be disposed on another end side of the C-shaped member, the guided member being guided by a guide member formed on a welded member support unit configured to support the first member to be welded and the second member to be welded. In accordance with the above, the positioning accuracy of the machining tool can be improved by combining the rotary drive motor, the guide member, and the guided member, and it is possible to enhance machining accuracy.

Further, from the fact that the jig is a C-shaped member, the rotary drive motor is arranged face-to-face with the guide member and the guided member across the boundary between the first member to be welded and the second member to be welded. For this reason, a portion of the force from the rotary drive motor or the support member actuator is received in the guide member, the guided member, and the jig. Therefore, it is possible to reduce the size or to lower the cost of the FSW device as a whole, or to improve the positioning accuracy or the machining accuracy of the machining tool.

The distal end of the articulated arm may be attached to a center of the C-shaped member. In accordance with this feature, it is possible to reduce a moment that acts on the C-shaped member during movement of the machining tool. Therefore, it is possible to reduce the size or to lower the cost of the FSW device as a whole, or to improve the positioning accuracy or the machining accuracy of the machining tool.

The controller may execute the counterforce compensation control when an output of the rotary drive motor exceeds an output threshold, and may stop the counterforce compensation control when the output of the rotary drive motor does not exceed the output threshold. In accordance with this feature, it is possible to limit situations in which the counterforce compensation control is executed, thereby mitigating the computational load in the controller. As a result, while maintaining machining accuracy, it is possible to increase the speed of task.

The controller may convert an actual current value or a target current value of the rotary drive motor into a magnitude of the counterforce, may convert the magnitude of the counterforce into a deflection compensation amount of the articulated arm in a direction of the counterforce, and may compensate a posture of the articulated arm depending on the deflection compensation amount. In accordance with this feature, it is possible to carry out the process of canceling out the counterforce easily and with high accuracy.

In the case that welding of the first member to be welded and the second member to be welded is carried out linearly, the controller may set a target start point and a target end point of the machining tool, during movement of the machining tool from the target start point to the target end point, may calculate a direction of the target end point with respect to a current position of the machining tool, and may move the machining tool in the direction of the target end point.

In accordance with this feature, in comparison with the case of, in addition to the target start point and the target end point of the machining tool, calculating a target trajectory connecting the target start point and the target end point and then moving the machining tool while compensating deviations between the target trajectory and the current position of the machining tool, the computational load of the controller can be alleviated. Along therewith, it is possible to simplify teaching or to increase the machining speed.

A friction stir welding system according to the present invention is characterized by being equipped with the above-described friction stir welding device, and a welded member support unit configured to support the first member to be welded and the second member to be welded.

In a friction stir welding method according to the present invention, there is used a friction stir welding device including a machining tool, a rotary drive motor configured to rotate the machining tool, a support member configured to support the machining tool and the rotary drive motor, a support member actuator configured to displace the support member, and a controller configured to control the rotary drive motor and the support member actuator, the method being characterized in that, when, in a state in which the machining tool while rotating is pressed in an axial direction thereof with respect to a first member to be welded and a second member to be welded, the machining tool is moved linearly or curvilinearly to thereby continuously weld together the first member to be welded and the second member to be welded, the controller executes a counterforce compensation control configured to control an output of the support member actuator so as to cancel out a counterforce that acts on the machining tool accompanying rotation of the machining tool.

### BRIEF DESCRIPTION OF DRAWINGS

FIG. 1 is an external view showing in a simplified manner the external appearance of a friction stir welding system according to an embodiment of the present invention;

FIG. 2 is a block diagram showing in a simplified manner the configuration of the friction stir welding device according to the embodiment;

FIG. 3 is a flowchart of an FSW control in the embodiment;

FIG. 4 is a plan view for describing a relationship between a direction of rotation and a target direction of advancement of a machining tool, a counterforce that acts on the machining tool, an actual direction of advancement of the machining tool in the case that a counterforce compensation control is executed, and an actual direction of advancement of the machining tool in the case that the counterforce compensation control is not executed; and

FIG. 5 is a flowchart (details of step S7 of FIG. 3) of the counterforce compensation control in the embodiment.

### DESCRIPTION OF EMBODIMENTS

### A. Embodiment

### A1. Configuration of Friction Stir Welding System 10

### (A1-1. Overall Configuration)

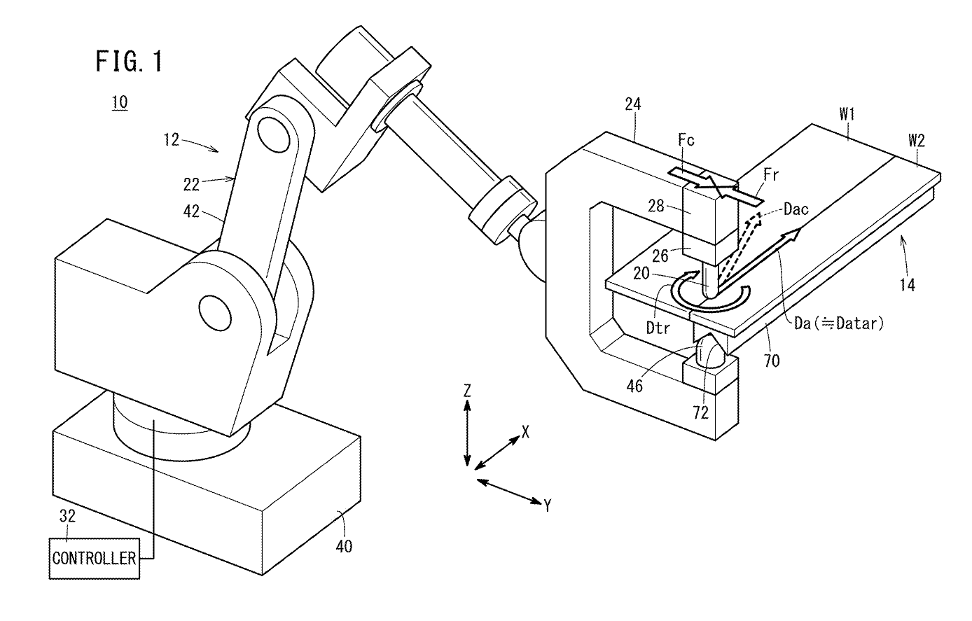

FIG. 1 is an external view showing in a simplified manner the external appearance of a friction stir welding system 10 (hereinafter referred to as an “FSW system 10”) according to an embodiment of the present invention. The FSW system 10 is equipped with a friction stir welding device 12 (hereinafter referred to as an “FSW device 12”) and a welded member support unit 14 (hereinafter also referred to as a “support unit 14”).

### (A1-2. FSW Device 12)

### (A1-2-1. Overall Composition of FSW Device 12)

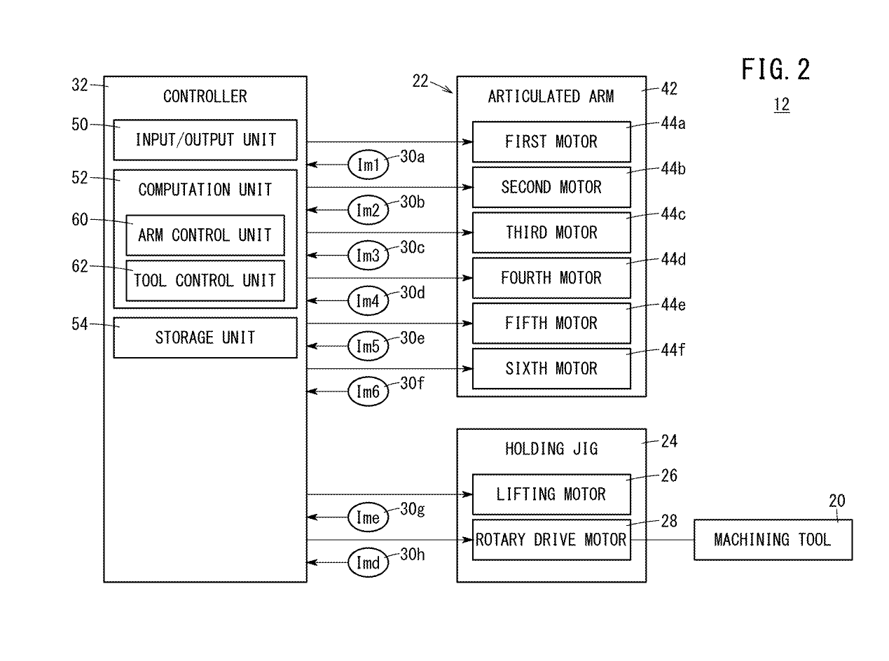

FIG. 2 is a block diagram showing in a simplified manner the configuration of the FSW device 12 according to the present embodiment. The FSW device 12 carries out FSW (friction stir welding) with respect to a first member to be welded W1 (hereinafter also referred to as a “first workpiece W1” or a “workpiece W1”) and a second member to be welded W2 (hereinafter also referred to as a “second workpiece W2” or a “workpiece W2.”). As shown in FIGS. 1 and 2, the FSW device 12 is equipped with a machining tool 20, an articulated robot 22 (hereinafter also referred to as a “robot 22”), a holding jig 24, a lifting motor 26, a rotary drive motor 28 (hereinafter also referred to as a “motor 28”), current sensors 30a to 30h, and a controller 32.

### (A1-2-2. Machining Tool 20)

The machining tool 20 is a member with a protrusion (probe) being formed on a distal end of a cylindrical body thereof, for joining or welding together the first workpiece W1 and the second workpiece W2 by being pressed in a rotating state against a boundary between the first workpiece W1 and the second workpiece W2.

### (A1-2-3. Articulated Robot 22)

The articulated robot 22 displaces the machining tool 20 with respect to the workpieces W1, W2. As shown in FIG. 1, the robot 22 is equipped with a base 40, and an articulated arm 42 (support member actuator) that is fixed on the base 40. The holding jig 24 is connected to a distal end of the articulated arm 42 (hereinafter also referred to as an “arm 42”), and the holding jig 24 can be moved by displacement of the arm 42. First through sixth motors 44a to 44f (hereinafter also referred to as “arm motors 44a to 44f”) (see FIG. 2) are incorporated into the respective joints of the arm 42.

### (A1-2-4. Holding Jig 24)

As shown in FIG. 1, the holding jig 24 (support member) is attached to the distal end of the articulated arm 42 in the center thereof, and supports the machining tool 20, the lifting motor 26, and the rotary drive motor 28. As shown in FIG. 1, the holding jig 24 is a C-shaped member. The machining tool 20, the lifting motor 26, and the rotary drive motor 28 are provided on one end side (an upper side in the present embodiment) of the holding jig 24, and a guided member 46 is provided on the other end side of the holding jig 24. The guided member 46 is guided by a guide member 70 (see FIG. 1), to be described later. As shown in FIG. 1, the guided member 46 of the present embodiment, for example, is made of metal, and a distal end side thereof (guide member 70 side) is hemispherical.

### (A1-2-5. Lifting Motor 26 and Rotary Drive Motor 28)

Responsive to a command from the controller 32, the lifting motor 26 displaces the machining tool 20 upwardly and downwardly (in the directions of the arrows Z). Responsive to a command from the controller 32, the rotary drive motor 28 causes the machining tool 20 to rotate.

### (A1-2-6. Current Sensors 30a to 30h)

The current sensors 30a to 30f detect input currents Im1 to Im6 (hereinafter also referred to as “consumption currents Im1 to Im6”) [A] to the respective arm motors 44a to 44f from a non-illustrated power supply, and outputs the detected input currents Im1 to Im6 to the controller 32. The current sensor 30g detects an input current Ime (hereinafter also referred to as a “consumption current Ime”) [A] to the lifting motor 26, and outputs the detected input current Ime to the controller 32. The current sensor 30h detects an input current Imd (hereinafter also referred to as a “consumption current Imd”) [A] to the rotary drive motor 28, and outputs the detected input current Imd to the controller 32.

### (A1-2-7. Controller 32)

The controller 32 executes a friction stir welding control (FSW control) by controlling the lifting motor 26, the rotary drive motor 28, and the articulated arm 42 (arm motors 44a to 44f). The FSW control of the present embodiment, in a state in which the machining tool 20 while rotating is pressed in an axial direction thereof with respect to the first workpiece W1 and the second workpiece W2, causes the first workpiece W1 and the second workpiece W2 to be joined or welded together continuously by moving the machining tool 20 linearly or curvilinearly.

As shown in FIG. 2, the controller 32 comprises an input/output unit 50, a computation unit 52, and a storage unit 54. The input/output unit 50 performs outputting of control signals to non-illustrated inverters that are arranged between the respective motors 26, 28, 44a to 44f and the non-illustrated power supply, and inputting of information from the current sensors 30a to 30f. The computation unit 52 controls the respective motors 26, 28, and 44a to 44f. The computation unit 52 includes an arm control unit 60 that controls the arm 42 through the arm motors 44a to 44f, and a tool control unit 62 that controls the machining tool 20 through the lifting motor 26 and the rotary drive motor 28.

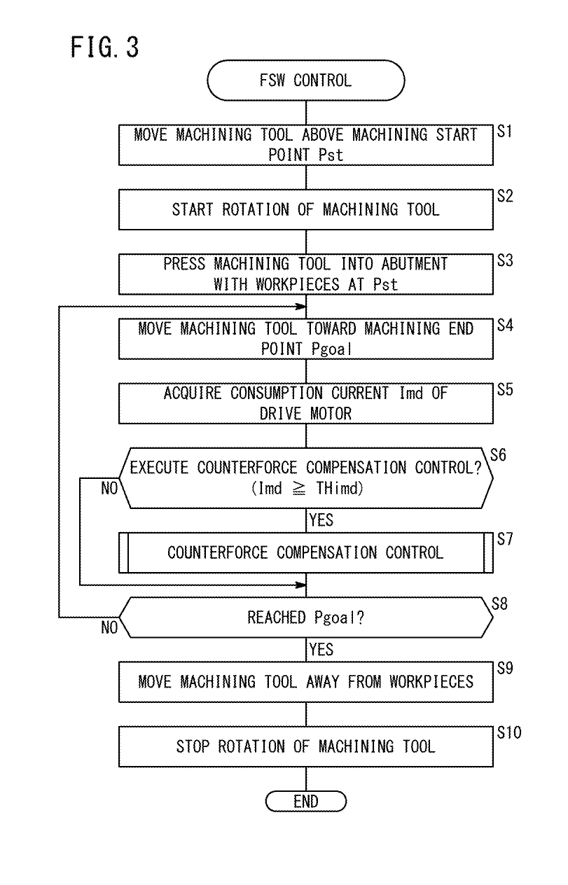

The arm control unit 60 calculates a deflection amount Qa [mm] of the arm 42 in XYZ directions (FIG. 1), and executes a deflection compensation control to compensate or correct the deflection amount Qa. Concerning the basic content of the deflection compensation control, for example, it is possible to use the control disclosed in U.S. Patent Application Publication No. 2004/0193293 or Japanese Laid-Open Patent Publication No. 2000-183128. However, as will be described later, according to the present embodiment, the counterforce compensation control, which compensates the deflection amount Qa on the basis of a counterforce Fr that acts on the machining tool 20, is implemented as part of the deflection compensation control. Details of the FSW control (including the counterforce compensation control) will be described later with reference to FIG. 3, etc.

### (A1-3. Welded Member Support Unit 14)

The welded member support unit 14 supports the first workpiece W1 and the second workpiece W2. Although in FIG. 1, the support unit 14 is shown as floating in the air, for example, both ends of the support unit 14 in the vicinity of a process start point Pst (target start point) and a process end point Pgoal (target end point) of the machining tool 20 are fixed to the ground.

As shown in FIG. 1, the guide member 70, which faces downwardly, is provided on the support unit 14. The guide member 70 has a V-shaped groove 72, and a cross section of the groove 72 in an imaginary plane perpendicular to a virtual line that connects the machining start point Pst (target start point) and the machining end point Pgoal (target end point) is in the form of a V-shape. The guide member 70 guides the guided member 46 that is provided on the holding jig 24.

### A2. FSW Control

### (A2-1. Overview of FSW Control)

As discussed above, the controller 32 executes the FSW control by controlling the lifting motor 26, the rotary drive motor 28, and the articulated arm 42 (arm motors 44a to 44f). The FSW control, in a state in which the machining tool 20 while rotating is pressed in an axial direction thereof (the Z direction in FIG. 1) with respect to the workpieces W1, W2, causes the workpieces W1, W2 to be welded together continuously by moving the machining tool 20 linearly or curvilinearly. Therefore, it is possible to further expand the applications than in the case of spot welding using FSW.

FIG. 3 is a flowchart of an FSW control in the present embodiment. Prior to starting the process of FIG. 3, the coordinates of the machining start point Pst (target start point) and the machining end point Pgoal (target end point) of the machining tool 20, a force (target pressing force Fptar) to be added with respect to the workpieces W1, W2 from the machining tool 20, and the thicknesses of the workpieces W1, W2, etc., are set.

Steps S1 and S8 of FIG. 3 are executed by the arm control unit 60 of the controller 32, steps S2 and S10 are executed by the tool control unit 62, and steps S3 through S9 are executed by both the arm control unit 60 and the tool control unit 62.

In step S1, the controller 32 controls the arm 42 (arm motors 44a to 44f) and moves the machining tool 20 above the process start point Pst. At this point in time, the arm 42 is moved to a position corresponding to the process start point Pst. In step S2, the controller 32 controls the rotary drive motor 28 and begins rotating the machining tool 20.

In step S3, the controller 32 controls the lifting motor 26 and the arm 42 (arm motors 44a to 44f), and presses the machining tool 20 into abutment with the workpieces W1, W2 at the process start point Pst. Moreover, in steps S3 through S8, the arm motors 44a to 44f and the lifting motor 26 are controlled to realize the target pressing force Fptar [kg·mm/s²] that was set beforehand. However, the actual pressing force Fp applied by the machining tool 20 undergoes changes due to variations in the thicknesses of the workpieces W1, W2, or due to contact by the arm 42 with the workpieces W1, W2, etc.

The actual pressing force Fp [kg·mm/s] by the machining tool 20 is calculated by the following formula (1).

Fp=k×Ip×t×98.00.0 (1)

in the above formula (1), k represents a coefficient. The variable Ip represents the consumption current [A] of the motor corresponding to the pressing axis. The variable t represents a torque constant [kg·mm/A] of the motor corresponding to the pressing axis. Further, the value 9800.0 represents the gravitational acceleration [mm/s²]. The pressing axis referred to herein implies an axis in the pressing direction (Z direction) from the machining tool 20 to the workpieces W1, W2. Therefore, the motor that corresponds to the pressing axis may be any one motor or a plurality of motors from among the arm motors 44a to 44f and the lifting motor 26.

In step S4, the controller 32 controls the arm 42 (arm motors 44a to 44f) and moves the machining tool 20 toward the machining end point Pgoal. As noted above, a deflection compensation control is executed during movement of the arm 42.

In accordance with the deflection compensation control, upon controlling the position (in particular, a distal end reference position) of the arm 42, a deflection amount Qa of the arm 42, which is caused by the weight of the arm 42 itself and the supported members that are supported by the arm 42, is taken into consideration.

According to the deflection compensation control, the storage unit 54 stores, in advance, deflection amount Qa of the posture deviation and/or the distal end position of the arm 42, which are measured at a plurality of positions within a region in which the arm 42 (or the robot 22) is operated, under a plurality of load conditions in which the weight and/or the center of gravity position differ.

Further, according to the deflection compensation control, while the robot 22 is under use, data of the deflection amount Qa approximately corresponding to the weight and/or the center of gravity position of the supported members that are attached to the distal end of the arm 42 (in this case, the machining tool 20, the holding jig 24, the lifting motor 26, and the rotary drive motor 28, etc.) are specified by the operator through the input/output unit 50. Furthermore, using the specified data of the deflection amount Qa, the controller 32 calculates deflection amounts Qa at the respective teaching point positions of the operating program for the robot 22. Furthermore, the controller 32 compensates and modifies the respective teaching point positions of the operating program depending on the calculated deflection amounts Qa.

In step S5, the controller 32 acquires the consumption current Imd of the rotary drive motor 28. In step S6, the controller 32 determines whether or not to execute the counterforce compensation control. More specifically, it is determined whether or not the consumption current Imd is greater than or equal to a current threshold THimd.

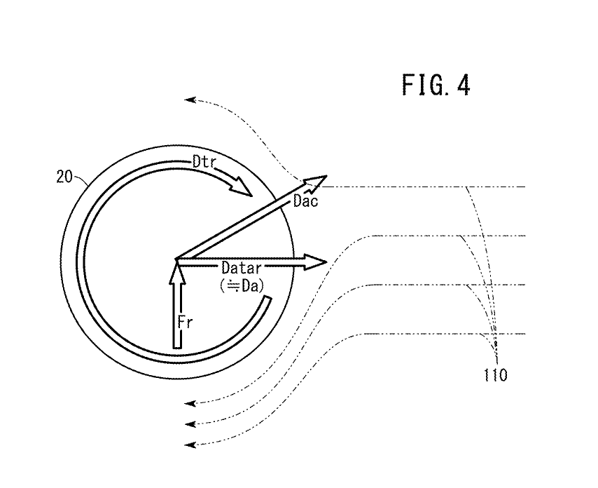

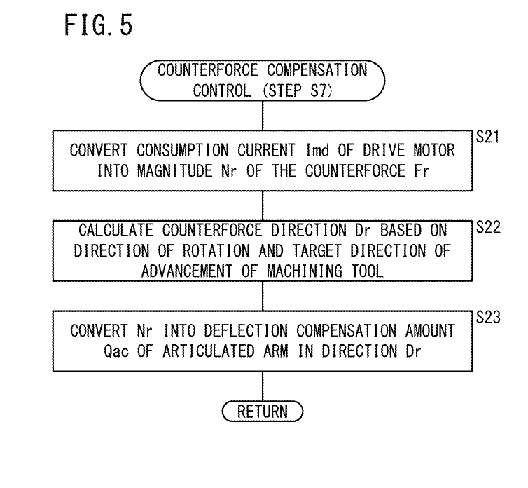

If the counterforce compensation control is to be executed (step S6: YES), then in step S7, the controller 32 executes the counterforce compensation control (to be described in detail later with reference to FIGS. 4 and 5). In the case that the counterforce compensation control is not to be executed (step S6: NO), then the process proceeds to step S8 without passing through step S7.

In step S8, the controller 32 determines whether or not the machining tool 20 has reached the machining end point Pgoal. If the machining tool 20 has not reached the machining end point Pgoal (step S8: NO), then the process returns to step S4. If the machining tool 20 has reached the machining end point Pgoal (step S8: YES), then the process proceeds to step S9.

In step S9, the controller 32 separates the machining tool 20 away from the workpieces W1, W2 by controlling the lifting motor 26 and the arm 42. Moreover, at this point in time, the workpieces W1, W2 are welded together integrally at least at the welded portion that was the target of the current machining process.

In step S10, the controller 32 controls the rotary drive motor 28 and stops rotation of the machining tool 20. Thereafter, in the case that another portion to be welded exists, the controller 32 repeats the process of FIG. 3. In the case that FSW in relation to all of the portions to be welded has been completed, then the controller 32 returns the machining tool 20 to its initial position by controlling the lifting motor 26 and the arm 42.

### (A2-2. Counterforce Compensation Control)

### (A2-2-1. Overview of Counterforce Compensation Control)

The arrow Da shown in FIG. 1 indicates a direction of advancement of the machining tool 20 in the case that the counterforce compensation control is executed, and coincides substantially with the target direction of advancement Datar of the machining tool 20. The arrow Dac indicates a direction of advancement of the machining tool 20 in the case that the counterforce compensation control is not executed. Further, the arrow Dtr indicates a direction of rotation Dtr of the machining tool 20. The arrow Fr indicates the counterforce that acts on the machining tool 20. The arrow Fc indicates a compensating force that is added to the machining tool 20 through the arm 42 in the counterforce compensation control.

FIG. 4 is a plan view for describing a relationship between the direction of rotation Dtr and the target direction of advancement Datar of the machining tool 20, the counterforce Fr that acts on the machining tool 20, the actual direction of advancement Da of the machining tool 20 in the case that the counterforce compensation control is executed, and an actual direction of advancement Dac of the machining tool 20 in the case that the counterforce compensation control is not executed. In FIG. 4, the arrows shown by the two-dot-dashed lined arrows 110 are indicative of the flow of the workpieces W1, W2.

In the case that the machining tool 20 is moved linearly or curvilinearly during rotation thereof, the workpieces W1, W2 become softened due to frictional heat. At this time, in relation to the workpieces W1, W2, drag, lift, and compression force act on the machining tool 20. Therefore, as shown in FIG. 4, the flow of the workpieces W1, W2 is asymmetrical when viewed along the target direction of advancement Datar. Along therewith, a counterforce Fr perpendicular to the target direction of advancement Datar is generated on the machining tool 20. Consequently, in the case that the counterforce compensation control is not executed, the actual direction of advancement Dac of the machining tool 20 becomes deviated or shifted from the target direction of advancement Datar.

Thus, according to the present embodiment, by controlling the output of the arm 42 so as to cancel out the counterforce Fr, the actual direction of advancement Da of the arm 42 is made to approximate or be brought closer to the target direction of advancement Datar. More specifically, when the machining tool 20 during rotation thereof is moved linearly or curvilinearly through the arm 42 and the holding jig 24, the controller 32 executes the counterforce compensation control for controlling the output of the arm 42 so as to cancel out the counterforce Fr that acts on the machining tool 20.

### (A2-2-2. Process Details of Counterforce Compensation Control)

FIG. 5 is a flowchart (details of step S7 of FIG. 3) of the counterforce compensation control in the present embodiment. Steps S21 through S23 of FIG. 5 are executed primarily by the arm control unit 60 of the controller 32. In step S21, the controller 32 converts the consumption current Imd of the rotary drive motor 28 into a magnitude Nr of the counterforce Fr. As for a relationship between the consumption current Imd and the magnitude Nr of the counterforce Fr, for example, a map is generated beforehand, and is stored in the storage unit 54.

In step S22, the controller 32 calculates the direction Dr of the counterforce Fr (hereinafter also referred to as a “counterforce direction Dr”) on the basis of the direction of rotation Dtr and the target direction of advancement Datar of the machining tool 20. By taking the current position of the machining tool 20 as a reference, the target direction of advancement Datar can be defined as a direction from the current position toward the machining end point Pgoal.

In step S23, the controller 32 converts the magnitude Nr of the counterforce Fr into a deflection compensation amount Qac (hereinafter also referred to as a “compensation amount Qac”) of the arm 42 in the counterforce direction Dr. The compensation amount Qac is a value for compensating the deflection amount Qa of the aforementioned deflection compensation control. Consequently, the controller 32 controls the position of the arm 42 by compensating for the deflection amount Qa using the calculated compensation amount Qac. It should be borne in mind that the compensation amount Qac herein is an amount toward the counterforce direction Dr, and is not necessarily an amount in a vertical direction.

### A3. Effects and Advantages of the Present Embodiment

According to the present embodiment as described above, when the machining tool 20 during rotation thereof is moved linearly or curvilinearly through the holding jig 24 and the articulated arm 42 (support member), the counterforce compensation control is executed (step S7 of FIG. 3, FIG. 5) for controlling the output of the arm motors 44a to 44f (support member actuator) so as to cancel out the counterforce Fr that acts on the machining tool 20 accompanying rotation of the machining tool 20. Owing to this feature, by moving the machining tool 20 while a deviation due to the counterforce Fr that acts on the machining tool 20 is compensated for, displacement of the machining tool 20 can be controlled highly accurately. Consequently, it is possible to carry out FSW of the first workpiece W1 and the second workpiece W2 with high precision. As a result, it is possible to expand the application of FSW performed by moving the machining tool 20 linearly or curvilinearly.

In the present embodiment, the controller 32 calculates the counterforce direction Dr on the basis of the direction of rotation Dtr of the machining tool 20 and the target direction of advancement Datar of the machining tool 20 (step S22 of FIG. 5). In accordance with this feature, it is possible to highly accurately estimate the deviation of the direction Dr of the counterforce Fr to be compensated. Consequently, it is possible to carry out FSW of the first workpiece W1 and the second workpiece W2 with higher precision.

In the present embodiment, the controller 32 calculates the magnitude Nr of the counterforce Fr on the basis of the consumption current Imd (actual output) of the rotary drive motor 28 (step S21 of FIG. 5). Owing to this feature, it is possible to highly accurately estimate the magnitude Nr of the counterforce Fr to be compensated. Consequently, it is possible to carry out FSW of the first workpiece W1 and the second workpiece W2 with higher precision.

In the present embodiment, the FSW device 12 includes the articulated arm 42, the holding jig 24 that supports the machining tool 20 and the rotary drive motor 28, and the plurality of arm motors 44a to 44f that are provided inside the articulated arm 42. The holding jig 24 is attached to a distal end of the arm 42 (see FIG. 1). Owing to this feature, it becomes possible to utilize a general-purpose articulated arm 42, whereby the cost of the FSW device 12 as a whole can be reduced.

In the present embodiment, the holding jig 24 is a C-shaped member, and the machining tool 20, the lifting motor 26, and the rotary drive motor 28 are disposed on one end side of the holding jig 24, while the guided member 46 is disposed on the other end side of the holding jig 24 (FIG. 1). In accordance therewith, the positioning accuracy of the machining tool 20 can be improved by combining the rotary drive motor 28, the guide member 70, and the guided member 46, and it is possible to enhance machining accuracy.

Further, from the fact that the holding jig 24 is a C-shaped member, the lifting motor 26 and the rotary drive motor 28 are arranged face-to-face with the guide member 70 and the guided member 46, thereby sandwiching the boundary between the first member to be welded W1 and the second member to be welded W2. For this reason, a portion of the force from the lifting motor 26, the rotary drive motor 28, or the arm motors 44a to 44f is received by the guide member 70, the guided member 46, and the holding jig 24 (support member). Therefore, it is possible to reduce the size or to lower the cost of the FSW device 12 as a whole, or to improve the positioning accuracy or the machining accuracy of the machining tool 20.

In the present embodiment, the distal end of the articulated arm 42 is attached to the center of the holding jig 24 (C-shaped member) (see FIG. 1). In accordance with this feature, it is possible to reduce a moment that acts on the holding jig 24 during movement of the machining tool 20. Therefore, it is possible to reduce the size or to lower the cost of the FSW device 12 as a whole, or to improve the positioning accuracy or the machining accuracy of the machining tool 20.

In the present invention, the controller 32 executes the counterforce compensation control (step S7) when the consumption current Imd (output) of the rotary drive motor 28 is greater than or equal to the threshold THimd (output threshold) (step S6 of FIG. 3: YES). Further, the controller 32 does not carry out the counterforce compensation control (or stated otherwise, stops the counterforce compensation control) when the consumption current Imd is not greater than or equal to the threshold THimd (step S6: NO). In accordance with this feature, it is possible to limit situations in which the counterforce compensation control is executed, thereby mitigating the computational load in the controller 32. As a result, while maintaining machining accuracy, it is possible to increase the speed of task.

In the present embodiment, the controller 32 converts the consumption current Imd (actual current value) of the rotary drive motor 28 into a magnitude Nr of the counterforce Fr (step S21 of FIG. 5). Then, the controller 32 calculates the direction Dr of the counterforce Fr on the basis of the direction of rotation Dtr and the target direction of advancement Datar of the machining tool 20 (step S22). Furthermore, the controller 32 converts the magnitude Nr of the counterforce Fr into a deflection compensation amount Qac of the articulated arm 42 in the direction Dr of the counterforce Fr (step S23). Further still, the controller 32 compensates the posture of the arm 42 (support member actuator) or the holding jig 24 (support member) responsive to the deflection compensation amount Qac. In accordance with this feature, it is possible to carry out the process of canceling out the counterforce Fr easily and with high accuracy.

In the present embodiment, in the case that welding of the first member to be welded W1 and the second member to be welded W2 is carried out linearly, the controller 32 sets the machining start point Pst (target start point) and the machining end point Pgoal (target end point) of the machining tool 20. Further, during movement from the machining start point Pst to the machining end point Pgoal, the controller 32 calculates the target direction of advancement Datar (direction of the machining end point Pgoal) with respect to the current position of the machining tool 20, and moves the machining tool 20 toward the target direction of advancement Datar (step S4 of FIG. 3). In accordance with this feature, in comparison with the case of, in addition to the machining start point Pst and the machining end point Pgoal of the machining tool 20, calculating a target trajectory connecting the machining start point Pst and the machining end point Pgoal and then moving the machining tool 20 while compensating deviations between the target trajectory and the current position of the machining tool 20, the computational load of the controller 32 can be alleviated. Along therewith, it is possible to simplify teaching or to increase the machining speed.

### B. Modifications

The present invention is not limited to the above embodiment, and as a matter of course, various alternative or modified configurations may be adopted therein based on the descriptive content of the present specification. For example, the following configurations can be adopted.

### B1. FSW Device 12 (Object of Application)

The FSW device 12 of the aforementioned embodiment includes the articulated robot 22 (see FIG. 1). However, for example, from the standpoint of canceling out the counterforce Fr that acts on the machining tool 20 when FSW is performed, the invention is not limited to this feature. For example, the present invention can be applied to a so-called gantry type FSW device. Further, since it is acceptable if force is generated in the target direction of advancement Datar of the machining tool 20 and in the direction Dr of the counterforce Fr, the actuators (support member actuators) that displace the machining tool 20 and the rotary drive motor 28 may be provided with at least two axes.

### B2. Lifting Motor 26, Rotary Drive Motor 28, and Arm Motors 44a to 44f

According to the above embodiment, the lifting motor 26, the rotary drive motor 28, and the arm motors 44a to 44f are used for controlling the machining tool 20 (see FIG. 2). However, for example, from the standpoint of enabling linear movement (or curvilinear movement) and rotation of the machining tool 20, the invention is not limited to this feature. For example, instead of the rotary drive motor 28, one motor (for example, the arm motor 44f) of the arm motors 44a to 44f (six axis motors) that forms a rotational axis can also be used for the purpose of rotating the machining tool 20. Alternatively, the lifting motor 26 may be omitted, and the machining tool 20 may be raised and lowered by the arm motors 44a to 44f. Alternatively, as disclosed in JP2003-205374A, a configuration can also be provided in which the machining tool 20 is arranged on the distal end of the arm 42.

### B3. Holding Jig 24 (Support Member)

According to the above embodiment, the holding jig 24 is a C-shaped member (see FIG. 1). However, for example, from the standpoint of supporting the machining tool 20 and the rotary drive motor 28, the invention is not limited to this feature. For example, the holding jig 24 can also be in the form of an X-shaped member.

### B4. Counterforce Compensation Control

In the above embodiment, the deflection compensation amount Qac is controlled in order to cancel out the counterforce Fr (step S23 of FIG. 5). However, for example, from the standpoint of canceling out the counterforce Fr, the invention is not limited to this feature. For example, it is also possible for the target direction of advancement Datar or the target movement position of the machining tool 20 to be compensated responsive to the counterforce Fr.

According to the above embodiment, although compensation is carried out on the basis of the target direction of advancement Datar (step S22), for example, from the standpoint of considering the counterforce Fr, compensation can also be performed on the basis of the actual direction of advancement Da. For example, the target direction of advancement Datar can be established beforehand as a provisional target direction of advancement Datar by a value in which the counterforce Fr is considered from the beginning, and a final target direction of advancement Datar can be realized by making the actual direction of advancement Da coincide with or approximate the target direction of advancement Datar.

In the above embodiment, the magnitude Nr of the counterforce Fr was estimated using the consumption current Imd of the rotary drive motor 28 (step S21 of FIG. 5). However, for example, from the standpoint of estimating the magnitude of the counterforce Fr, the invention is not limited to this feature. For example, the controller 32 may calculate the magnitude of the counterforce Fr on the basis of a target current of the rotary drive motor 28. Alternatively, the controller 32 can also calculate the magnitude of the counterforce Fr on the basis of the power consumption or a target power of the rotary drive motor 28.

According to the above embodiment, the counterforce compensation control is executed (step S7) when the consumption current Imd of the rotary drive motor 28 is greater than or equal to the output threshold THimd (step S6 of FIG. 3: YES), and the counterforce compensation control is stopped when the consumption current Imd is not greater than or equal to the output threshold THimd (step S6: NO). However, for example, from the standpoint of canceling out the counterforce Fr, it is possible for the counterforce compensation control to be carried out at all times during the period that FSW is being performed by the machining tool 20.

According to the above embodiment, when the machining tool 20 is moved in a linear manner, only the machining start point Pst and the machining end point Pgoal are set, and target points therebetween are not set (refer to FIG. 3). However, for example, from the standpoint of canceling out the counterforce Fr, the invention is not limited to this feature. For example, a target trajectory (a set of target points) from the machining start point Pst to the machining end point Pgoal can be set, a deviation (distance) between the current position of the machining tool 20 and the target trajectory can be calculated, and then the target direction of advancement Datar or a target advancement position of the machining tool 20 can be set so as to compensate for the deviation.

According to the above embodiment, a case has been described in which the machining tool 20 is moved in a linear manner (FIG. 1). However, for example, from the standpoint of canceling out the counterforce Fr that is specified on the basis of the direction of rotation Dtr and the target direction of advancement Datar of the machining tool 20, it is also possible for the machining tool 20 to be moved in a curved or curvilinear manner.

1. A friction stir welding device comprising:
a machining tool;
a rotary drive motor configured to rotate the machining tool;
a support member configured to support the machining tool and the rotary drive motor;
a support member actuator configured to displace the support member; and
a controller configured to control the rotary drive motor and the support member actuator;
wherein, when, in a state in which the machining tool while rotating is pressed in an axial direction thereof with respect to a first member to be welded and a second member to be welded, the machining tool is moved linearly or curvilinearly to thereby continuously weld together the first member to be welded and the second member to be welded, the controller executes a counterforce compensation control configured to control an output of the support member actuator so as to cancel out a counterforce that acts on the machining tool accompanying rotation of the machining tool.

2. The friction stir welding device according to claim 1, wherein the controller calculates a direction of the counterforce based on a direction of rotation of the machining tool and a target direction of advancement or an actual direction of advancement of the machining tool.

3. The friction stir welding device according to claim 1, wherein the controller calculates a magnitude of the counterforce based on an actual output or a target output of the rotary drive motor.

4. The friction stir welding device according to claim 1, wherein:
the support member includes an articulated arm, and a jig configured to support the machining tool and the rotary drive motor;
the support member actuator includes a plurality of arm motors that are provided inside the articulated arm; and
the jig is attached to a distal end of the articulated arm.

5. The friction stir welding device according to claim 4, wherein:
the jig is a C-shaped member;
the machining tool and the rotary drive motor are disposed on one end side of the C-shaped member; and
a guided member is disposed on another end side of the C-shaped member, the guided member being guided by a guide member formed on a welded member support unit configured to support the first member to be welded and the second member to be welded.

6. The friction stir welding device according to claim 5, wherein the distal end of the articulated arm is attached to a center of the C-shaped member.

7. The friction stir welding device according to claim 1, wherein the controller:
executes the counterforce compensation control when an output of the rotary drive motor exceeds an output threshold; and
stops the counterforce compensation control when the output of the rotary drive motor does not exceed the output threshold.

8. The friction stir welding device according to claim 4, wherein the controller:
converts an actual current value or a target current value of the rotary drive motor into a magnitude of the counterforce;
converts the magnitude of the counterforce into a deflection compensation amount of the articulated arm in a direction of the counterforce; and
compensates a posture of the articulated arm depending on the deflection compensation amount.

9. The friction stir welding device according to claim 1, wherein, in a case that welding of the first member to be welded and the second member to be welded is carried out linearly, the controller:
sets a target start point and a target end point of the machining tool;
during movement of the machining tool from the target start point to the target end point, calculates a direction of the target end point with respect to a current position of the machining tool; and
moves the machining tool in the direction of the target end point.

10. A friction stir welding system comprising:
a friction stir welding device; and
a welded member support unit configured to support a first member to be welded and a second member to be welded,
wherein the friction stir welding device comprises:
a machining tool;
a rotary drive motor configured to rotate the machining tool;
a support member configured to support the machining tool and the rotary drive motor;
a support member actuator configured to displace the support member; and
a controller configured to control the rotary drive motor and the support member actuator, and
wherein, when, in a state in which the machining tool while rotating is pressed in an axial direction thereof with respect to the first member to be welded and the second member to be welded, the machining tool is moved linearly or curvilinearly to thereby continuously weld together the first member to be welded and the second member to be welded, the controller executes a counterforce compensation control configured to control an output of the support member actuator so as to cancel out a counterforce that acts on the machining tool accompanying rotation of the machining tool.

11. A friction stir welding method using a friction stir welding device comprising a machining tool, a rotary drive motor configured to rotate the machining tool, a support member configured to support the machining tool and the rotary drive motor, a support member actuator configured to displace the support member, and a controller configured to control the rotary drive motor and the support member actuator;
wherein, when, in a state in which the machining tool while rotating is pressed in an axial direction thereof with respect to a first member to be welded and a second member to be welded, the machining tool is moved linearly or curvilinearly to thereby continuously weld together the first member to be welded and the second member to be welded, the controller executes a counterforce compensation control configured to control an output of the support member actuator so as to cancel out a counterforce that acts on the machining tool accompanying rotation of the machining tool.
